(19) United States
(12) Patent Application Publication
(10) Pub. No.: US 2026/0141338 A1
(43) Pub. Date: May 21, 2026

(54) SYSTEMS AND METHODS FOR MACHINE LEARNING MODELING OF EMBEDDING SPACE MAPPING

(71) Applicant: Dstillery, Inc., New York, NY (US)

(72) Inventors: Amelia Grieve WHITE, Old Greenwich, CT (US); Chen-Chi CHIEN, New York, NY (US); Mark Alan JUNG, Lewisville, TX (US); Taejin IN, Jamison, PA (US); Antonio COLLAZO, Floral Park, NY (US); Melinda Han WILLIAMS, Brooklyn, NY (US)

(21) Appl. No.: 18/949,761

(22) Filed: Nov. 15, 2024

(51) Int. Cl. G06Q 10/087; G06Q 30/0202; G06Q 30/0601

(52) U.S. Cl. CPC G06Q 10/087; G06Q 30/0202; G06Q 30/0631

(57) ABSTRACT

A non-transitory, processor readable medium storing code configured to be executed by a processor includes code comprising instructions to: identify a position of each website in a text embedding; train a first machine learning model to predict at least one of (i) a position in the text embedding given a position in a website embedding or (ii) a position in the website embedding given a position in the text embedding; access a second machine learning model trained to predict a conversion likelihood; identify a position of a non-website target inventory in the text embedding; apply the first machine learning model and the second machine learning model to the position of the target inventory in the text embedding to predict the likelihood of conversion; and facilitate delivery of an item of targeted content to the target inventory based on the conversion likelihood associated with the target inventory.

### FIELD

Some embodiments described herein relate to the generation and/or use of website embeddings and text embeddings. Website embeddings can encode relationships between websites, and text embeddings can encode semantic relationships between text entities. Embodiments described herein relate to computationally efficient techniques for leveraging textual inventories to identify positions of arbitrary inventories and leveraging website inventories to encode behavioral data. Machine learning models can be used to correlate website-based behavioral data to arbitrary non-website target inventories.

### BACKGROUND

Techniques developed for targeting users on websites do not directly translate to non-website inventory, such as connected television (CTV), mobile apps, audio inventory, or other digital out-of-home platforms. Traditional web-based advertising relies heavily on tracking mechanisms such as cookies, opt-in identifiers, and/or browser fingerprints to follows users across their browsing journeys. These tools allow advertisers to build detailed profiles and serve highly targeted ads. However non website inventory, including CTV, operates in environments where cookies and other common tracking mechanisms are either limited or entirely unavailable. This shift poses a technical challenge in identifying suitable targeted content to associate with such inventory, as known techniques for identifying audiences are not applicable.

For connected TV, the challenge is particularly acute. CTV devices like smart TVs and streaming sticks do not use traditional browsers, so cookies are absent. Additionally, CTV often operates on a shared screen, which is used by multiple people in a household, further complicating attempts at targeting. Unlike web-based advertising where individual users can often be uniquely identified, CTV targeting needs to consider multiple viewers with potentially diverse interests. Without precise user data, advertisers must rely on contextual and household level data to predict viewer interests which lacks the granularity typically available on websites.

The lack of consistent identifiers also affects non-website inventories such as mobile apps and digital out of home platforms. While mobile apps can track some user behavior, restrictions on mobile advertising identifiers limit the ability to identify users and identify suitable targeted content. Audio inventory faces similar restrictions. Podcasts or streaming music platforms may be associated with a user login, but the ability to track user behavior, especially behavior outside of that specific platform, is limited. Digital out of home displays, like those in public spaces, have even fewer options to identify the viewing audience and to target suitable content. Here the challenge is not only the absence of tracking mechanisms but also the dynamic and often anonymous nature of the audience in digital out of home platforms.

Given these limitations, targeting for non-website inventory requires innovative solutions that do not rely on cookies or traditional user identifiers. In CTV techniques like deterministic and probabilistic matching, which attempt to connect TV devices with household level data using methods like IP matching, are gaining traction. For digital out of home platforms targeting is more likely to leverage environmental contexts such as time of day location and general demographic patterns in a given area. These approaches are not perfect substitutes for cookie-based targeting but represent attempts to tailor advertising in environments where user specific data is hard to obtain.

Non-website inventories and CTV present novel technical challenges to behavioral based targeting of suitable content. Similarly stated, while some historical methods of audience identification using, for example, demographics and/or the content of the inventory may exist, a need exists to address the significant technical limitations to targeting content to non-website (typically digital) inventories based on observed behavioral data.

### BRIEF DESCRIPTION OF THE DRAWINGS

FIG. 1 is a schematic illustration of a system that includes an inventory evaluation and allocation device, according to an embodiment.

FIG. 2 is a visualization of the internet generated by a technique that includes embedding websites in a p-dimensional space, according to an embodiment.

FIG. 3 is a simplified schematic illustration of a text embedding.

FIG. 4 is a flow chart of a method of using generative artificial intelligence in conjunction with the inventory evaluation and allocation device, according to an embodiment.

FIG. 5 is a flow chart of a method of using an inventory evaluation and allocation device, according to an embodiment.

FIG. 6 is a flow chart of a second method of using an inventory evaluation and allocation device, according to an embodiment.

### DETAILED DESCRIPTION

Some embodiments described herein relate to a computer-implemented method that includes accessing a text embedding and identifying a position of each website from a plurality of websites in the text embedding. A first machine learning model can be trained using the position of each website from the plurality of websites in the text embedding to predict at least one of (i) a position in the text embedding given a position in a website embedding or (ii) a position in the website embedding given a position in the text embedding. A second machine learning model that is trained to predict a conversion likelihood based on behavioral data representing user interactions with a second plurality of websites. A position of a target inventory in the text embedding can be identified where the target inventory is not a website. The first machine learning model and the second machine learning model can be applied to the position of the target inventory in the text embedding to predict the likelihood of conversion. An item of targeted content has its delivery to the target inventory facilitated based on the conversion likelihood associated with the target inventory.

Some embodiments described herein relate to a computer-implemented method that includes identifying a target inventory; prompting a generative AI with the target inventory, wherein the prompt causes the generative artificial intelligence to produce keywords associated with the target inventory; accessing a text embedding; and assigning a position in the text embedding for the target inventory based on an output of the generative AI.

Some embodiments described herein relate to a computer-implemented method that includes accessing a website embedding; accessing a text embedding; as well as identifying a position of a target inventory in the text embedding, where the target inventory is not a website. Training data may be defined by assigning a position in the text embedding to each website from a plurality of websites, each website from the plurality of website having a position in the website embedding. A first machine learning model can then be trained, using the training data, to output a position in the website embedding, given a position in the text embedding and/or vice versa. The first machine learning model can be applied to the target inventory to identify a target position in the website embedding based on a position of the target inventory in the text embedding. A second machine learning model can be applied to the position of the target inventory in the website embedding, the second machine learning model trained to predict a conversion likelihood based on a position in the website embedding. An item of targeted content then has its delivery to the target inventory facilitated based on the conversion likelihood associated with the target inventory.

U.S. patent application Ser. No. 18/779,937, entitled ARTIFICIAL INTELLIGENCE AND/OR MACHINE LEARNING MODELS TRAINED TO PREDICT USER ACTIONS BASED ON AN EMBEDDING OF NETWORK LOCATIONS, the entire disclosure of which is hereby incorporated by reference in its entirety, includes a description of the generation and/or use of embedding spaces.

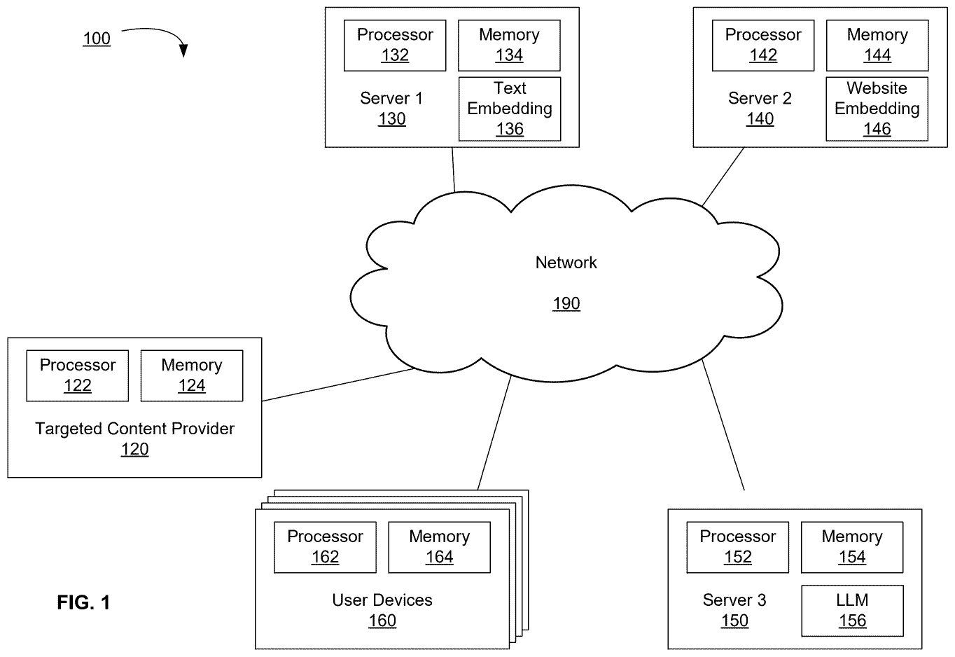

FIG. 1 is a schematic illustration of a system 100, according to an embodiment. The system 100 includes a targeted content provider 120, one or more webservers (also referred to herein as servers) 130, 140, 150 and one or more user devices 160, each communicatively coupled via a network 190. The network 190 can be the internet, an intranet, a local area network (LAN), a wide area network (WAN), a virtual network, a telecommunications network, any other suitable communication system, and/or combination of such networks. The network 190 can be implemented as a wired and/or wireless network.

The user devices 160 are computing entities, such as personal computers, laptops, tablets, smartphones, or the like, each having a processor 162 and a memory 164. The processor 162 can be, for example, a general purpose processor, a graphics processing unit, an AI-accelerator, a neural processing unit, a Field Programmable Gate Array (FPGA), an Application Specific Integrated Circuit (ASIC), a Digital Signal Processor (DSP), and/or the like. The processor 162 can be configured to retrieve data from and/or write data to memory, e.g., the memory 164, which can be, for example, random access memory (RAM), memory buffers, hard drives, databases, erasable programmable read only memory (EPROMs), electrically erasable programmable read only memory (EEPROMs), read only memory (ROM), flash memory, hard disks, floppy disks, cloud storage, and/or so forth. Each user device 160 can be operable to access network 190 (e.g., the internet) and visit websites and/or non-website content (e.g., streaming media, apps, etc.)

FIG. 1 further illustrates three servers: server 130; server 140; and server 150. Server 130, server 140, and server 150, can each be or include one or more computing entities, such as commodity or custom rack mounted servers. In some embodiments, servers 130, 140, and/or 150 can also be or include any other suitable computing device, such as personal computers, laptops, smartphones, or the like. Servers 130, 140, and 150 each have a processor 132, 142, 152 and a memory 134, 144, 154, respectively. Server 130 can store a text embedding 136 in memory 134. Server 130 is also referred to herein as a text embedding server. Server 140 may can store a website embedding 146 in memory 144. Server 140 is also referred to herein as a website embedding server. Server 150 can store a large language model (LLM) 156 in memory 154. Server 150 is also referred to herein as a LLM server. The processors 132, 142, 152 and/or memory 134, 144, 154 can be structurally and/or functionally similar to processor 162 and/or memory 164 described above.

The text embedding server 130, the website embedding server 140, the LLM server 150, and the target content provider 120, are shown and described as discrete entities for ease of discussion. It should be understood, however, that any functionality provided by any compute devices described herein, or any data stored on any of the compute devices may be distributed across any number of servers and/or functions, and the data storage may be distributed or combined in any number of combinations. As one example, a single server (or logical server cluster) can store the text embedding 136 and website embedding 146. Any other structures, logical functions, and/or stored processes can be grouped or distributed across any suitable number of physical and/or logical servers.

The targeted content provider 120 can be a computing entity operable to select, deliver, and/or facilitate the delivery of one or more items of targeted content. For example, the targeted content provider 120 can be associated with an advertiser or advertising network that provides targeted content that is displayed by a user device 160. Similarly stated, targeted content selected, delivered, or facilitated by the targeted content provider 120 can include advertisements embedded within, displayed with, or otherwise associated with webpages, streaming media, mobile applications (“apps”), etc. The targeted content provider 120 includes a processor 122 and a memory 124, which can be structurally and/or functionally similar to the processor 162 and/or memory 164, respectively, discussed above.

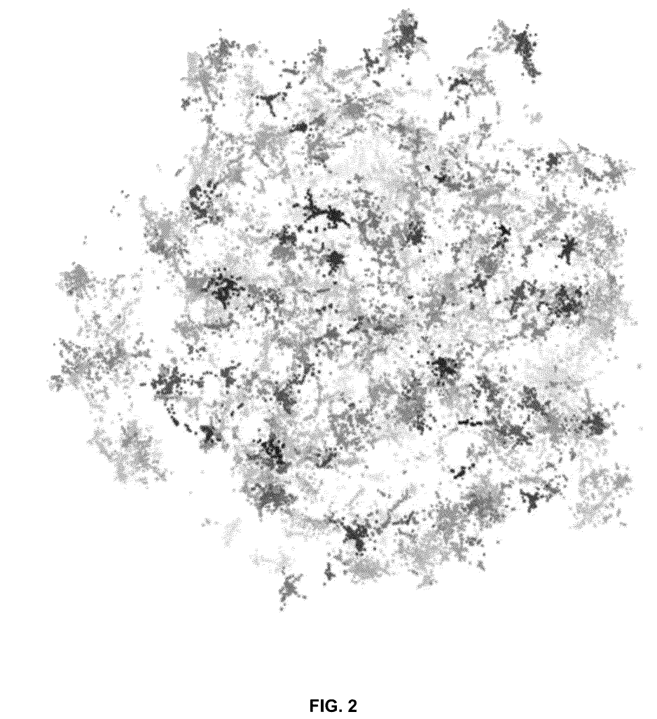

The website embedding server 140 is a compute device operable to collect and manage data on user behavior, website visits, and conversion events. The website embedding server 140 can be operable to receive, for example from websites, data points like page views, clicks, time spent on the specific sections, scroll depth, sequence of websites visited, etc. Through this information, the embedding server can define the website embedding 146, discussed in further detail below with reference to, for example, FIG. 2.

The website embedding server 140 can also be operable to receive conversion event data: actions that signify a user moving through a sales or engagement funnel, like product purchases, form submissions, or other key milestones. By tracking these events, the server provides insights into how effectively a website converts visitors into customers. Conversion event data typically includes an indication of a website and an indication of conversion (or conversion rate) associated with that website.

The website embedding 146 can be used in the training of a machine learning model to predict conversion event likelihoods given a position in a website embedding. Selecting targeted content for a given inventory can also be performed by a target content provider utilizing this information and these techniques.

In some instances, some or all user devices 160, may be configured not to send signals indicative of behaviors of users associated with such user devices 160, and/or may be configured not to send identifiers of any kind (e.g., cookie identifier, IP address, etc.). Similarly stated, browsers or other hardware and/or software associated with some or all user devices may prevent data associated with cookies or other unique identifying information from being sent to servers. In some such instances, a non-unique identifier—an identifier shared by a sufficiently large number of users (hundreds, thousands, tens of thousands, etc.)—can be sent directly or indirectly to servers. The non-unique identifier can be associated with aggregate, summarized, and/or otherwise anonymized behavioral data for the group of users associated with that non-unique identifier. Additionally, in some instances, information indicative of user behavior (e.g. website visitation records) can be received directly from a subset of the user devices 160 and/or a separate group of users (e.g., a group of users who have opted in to having their activity tracked) or indirectly (e.g., from a privacy sensitive aggregator and/or anonymizing service).

Conversion event data can include, for example, purchase information from purchase confirmation websites, purchase history associated with a user account, a credit reporting bureau, customer loyalty program, survey information, or any other suitable source. Conversion event data can also include information regarding whether a user took any suitable brand action, such as clicking on a predefined advertisement or like, visiting a predefined website, physically visiting a retail location, or any other suitable action. Conversion event data can include information not relating to any particular brand, such as visiting one of a set of predefined websites indicating interest in a product category, activity, or other interest. Conversion event data can identify users who undertook conversion actions or can be anonymized and/or aggregated. For example, targeted content can be served on a specific website, for example without knowing or receiving any other information about the user devices that visited that specific website, and conversion information for that group of users (e.g., an aggregate click-through rate) can be determined and/or received.

Machine learning techniques performed by the targeted content provider 120, the text embedding server 140, and/or any other suitable compute device can be operable to predict user affinity for non-website inventory based on the non-website inventory's similarity to websites and/or users' website-based behavioral data. In addition or alternatively, the LLM server 150 can be operable to prepare and/or transmit analytics and/or other suitable reports that can aid a marketer or other suitable entity to understand non-website inventories.

A p-dimensional space, also known as a p-dimensional vector space, is a mathematical coordination where each point or element in the space can be represented by a sequence of p numbers or coordinates. For example, a 1-dimensional space corresponds to a line specified by a single coordinate, a 2-dimensional space corresponds to a plane where each point has coordinates (typically (x, y)), a 3-dimensional space represents a 3D environment, and so on. P-dimensional space generalizes this relationship of representing points with p coordinates, making it possible to describe and analyze spaces with more than three dimensions.

FIG. 2 is a visualization of the internet generated by a technique that includes embedding websites in a p-dimensional space, according to an embodiment. Clustering and/or mapping websites according to methods described herein can serve to identify similarities between websites that are not otherwise discernable. For example, known methods of mapping the internet typically involve associating websites that link to each other or have common key words. Unlike known methods, embodiments described herein can be used to identify similarities between websites based on actual patterns of user interaction with websites. Known techniques for mapping the internet are generally inadequate to identify groups of websites based on actual visitor behavior.

Meaningful distances between websites can be established by defining an embedding. An embedding is a relatively low-dimensional, learned continuous vector space representation of a group of relatively high-dimensional vectors. Generating an embedding allows for the reduction of dimensionality while meaningfully representing the high-dimensional vectors in the embedding space.

A website embedding is a mapping from a website to a point in a p-dimensional vector space, where websites containing similar content are mapped to nearby points. Website visitation data can be received from a number of users whose internet activity has been monitored (e.g., by cookie-based tracking or any other suitable technique). In some instances, website visitation from over 1,000,000, over 100,000,000, over 200,000,000 or over 500,000,000 users would be received. As discussed above, however, in other instances, cookie-based tracking may be unavailable for significant portions of users due to recent increases in private-browsing initiatives. Accordingly, in some instances the website visitation data received can be from a relatively small (hundreds to tens of thousands) number of users who have agreed to be tracked. Preferably the users whose internet activity has been monitored is a representative subset of the general internet browsing public. Weights and other suitable data processing techniques can be applied to behavioral data to compensate for demographic and/or behavioral deviations between the monitored users and the general internet browsing public. In some instances, the website visitation data for each user may include a list of all websites visited by that user and the order in which the websites were visited. In other instances, pairs of sequential website visitation events for a user can be stored for limited periods of time, optionally without any user identifiers, which can avoid the need to store full histories associated with specific users.

An embedding of the websites in p-dimensional space can be defined based on the associations between the websites, creating a p-dimensional map of the internet. 128 is an example of a suitable p, and, for ease of description, references herein to 128 should be understood as referring to p. It should be understood, however, that p can be any suitable integer greater than 1, such as 3, 4, 10, 50, 100, 200, or 500.

For example if multiple users are observed visiting www.netflix.com and www.hbo.com within a predetermined period of time and/or within a predetermined sequence (e.g., within 20 minutes, within an hour, without visiting any intervening websites, with fewer than five intervening websites, etc.), and similarly, multiple users (not necessarily the same users) are observed visiting www.tvtropes.com and www.hbo.com, then www.tvtropes.com and www.netflix.com can be mapped closer to each other in the 128-dimensional embedding. Moreover, two websites (target websites) viewed in the same context (where context is the sequence of websites visited before or after the target website) can be moved closer to each other based on the frequency of websites viewed in the same context as observed over the set of all users.

Clusters of websites can be characterized and/or users can be associated with one or more clusters of websites. For example, a cluster of websites can be characterized by analyzing the website visitation data of users who visit websites within that cluster (e.g., users whose website visitation data indicates a minimum number of visits to websites in that cluster). Features of users who visit a particular cluster can be used to describe or classify that cluster. For example, if website visitation data of visitors to websites within a cluster characteristically overindexes a particular website (a particular website appears more frequently than it does in website visitation data of a random sample of users), that overindexing website can be used to characterize the cluster. Typically, the overindexing website will be within the cluster, but in some instances, a cluster can be characterized by an overindexing website that is not within the cluster or an overindexing cluster other than that cluster.

The website clusters may also be used to describe users or groups of users. For example, if one user has visited only www.tvtropes.com and another has visited only www.netflix.com, without clustering such websites together, it would not be obvious that those users share an actionable similar website visitation history. Grouping the websites into clusters provides a way to capture multiple actions under the same label and provides more descriptive power for understanding audiences and/or selecting audiences to receive targeted content.

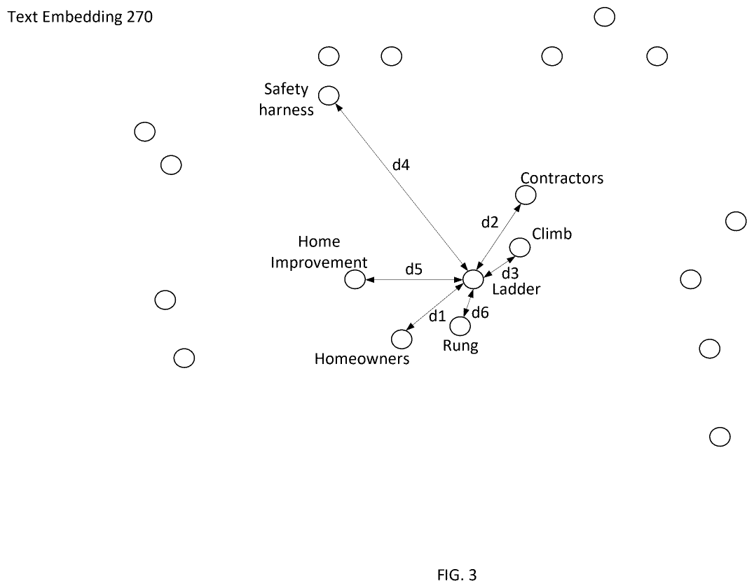

FIG. 3 is a simplified schematic illustration of a text embedding 270, according to an embodiment. Distance d1 represents a semantic similarity between “ladder” and “homeowners.” The shorter distance d6 between “rung” and “ladder” than the distance d5 between “home improvement” and “ladder” or distance d1 represents that “homeowners” is more semantically similar to “ladder” than “home improvement” or “homeowners.” Similarly, “contractors,” “climb,” and “safety harness” have positions in the text embedding space and the distance between “contractors,” “climb,” and “safety harness” and “ladder” (d2, d3, and d4, respectively) represents the semantic similarity between these words.

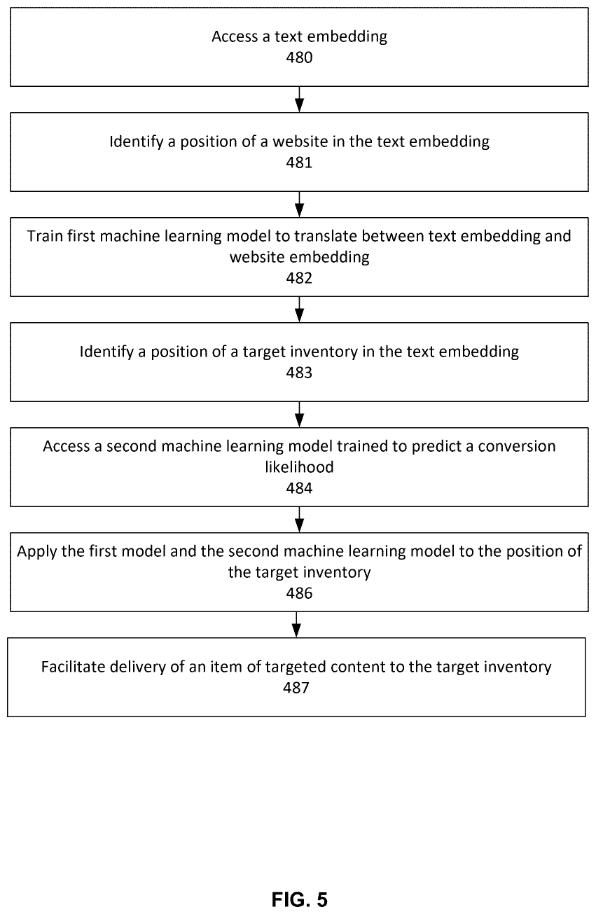

Keywords can be generated for arbitrary inventory including, for example, non-website inventory, such as streaming media and/or mobile apps. For example, a CTV home improvement show could be assigned keywords “homeowners” and “contractors.” The inventory associated with such a CTV show can be assigned a score, for example, based on the positions of the keywords and/or an aggregated (sum, mean, median, product, minimum or any other suitable combination or metric summarizing or representing the vectors associated with “homeowners” and/or “contractors” in the text embedding vector space). As discussed in further detail herein, for example with reference to FIG. 5, text embeddings, such as that represented in FIG. 3 and/or positions in text embeddings can be used by machine learning models to predict suitable targeted content for an arbitrary inventory based on behavioral data collected in association with websites, even when target inventory is not a website.

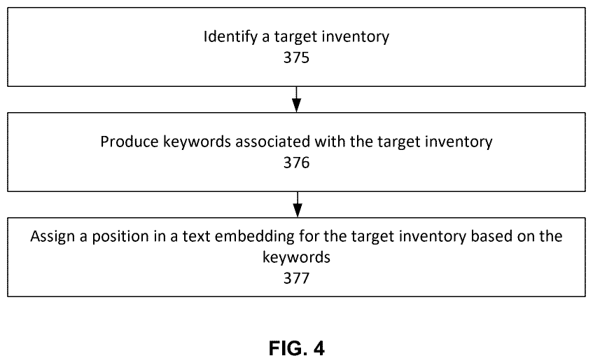

FIG. 4 is a method flowchart depicting a how a targeted content provider interacts with a system, such as a targeted content provider 120 interacting with LLM server 150. In the example of FIG. 4, a generative AI can be prompted for keywords or a text description. Keywords or text-based descriptions can be generated for websites and/or any other type of inventory. This allows for identifying a word, words, and/or a vector defining a position in the text embedding for a non-word object (e.g., a website or non-website inventory such as CTV or applications).

At block 375, a target inventory is identified. Target inventory can be, for example, any suitable content or media with which an advertisement or other item of targeted content can be associated. Embodiments described herein are particularly well suited for non-website inventory, such as CTV content, streaming media, mobile apps, audio, or in-app placement opportunities. In particular, website-based targeting strategies may be unsuitable or inaccurate when applied to non-website content. In particular, website-based behavioral data used to target website-based inventory is generally inapplicable to non-website inventory. Further, significant challenges exist accurately characterizing non-web inventories. For example, scraping descriptions of non-website inventory may be polluted with terms that do not reliably identify the content or audience, such as “award winning,” “five stars,” “what's new,” or version update logs.

Embodiments described herein generally relate to leveraging text embeddings to link web-based behavioral data to arbitrary inventories. However, as discussed above, historically, there have been technical challenges associated with identifying a position in a text embedding that is associated with an inventory. At 376, keywords associated with a target inventory are produced by prompting a generative AI to produce keywords associated with the targeted inventory. Prompting keywords for CTV (or any suitable inventory) can enable text embedding-based data and analytics using the distance and scoring methods discussed herein. An example prompt follows:
You are a keyword recommender that provides keywords for a genre of CTV. Please provide 3 keywords that are related to each of the TV genre given by user. Return your response in json format.

Similar examples can be used for applications or any other suitable inventory or for websites. For websites, an example prompt is:
You are a keyword recommender that provides keywords for websites. Please provide 5 keywords that best describe the contents of the given website. Return your response in json format.

In these examples, the number of keywords may be varied. For some categories, fewer than five words may be used if there are insufficient descriptors, causing a better performance. In other instances, more than five words may be useful. For each category, differing numbers of keywords may be used (e.g., five keywords for websites and three keywords generated for the example CTV genres).

Additionally or alternatively, the generative AI may be prompted for a description rather than keywords; a description, as well as to write a new prompt that includes both the name and the description in the prompt, and to provide keywords and/or to summarize and standardize an app/website into a description or keywords based on information about the app/website from another source, which is fed into the generative AI. For example, the generative AI may be prompted to scrape the google play store for information about a particular app. A webpage can also be scraped for information about the webpage or non-webpage inventory. In other words, the generative AI can be fed information the AI does not already “know” in order to expand the knowledge base. The following prompt may be used for a description:
You are a description provider that provides short descriptions for a TV genre. Please provide a short description (within 20 tokens) that best explains the given genre.

After the keywords are produced, at 376, a position in a text embedding is assigned as shown in block 377. The output from the generative AI is then taken, and the vector-based representations of the text embeddings across multiple keywords are averaged. It is also possible to input text of arbitrary length (e.g., a string of keywords, a full paragraph of text, etc.) to obtain a position in the text embedding, at 377. It may, however, be preferable to average, or otherwise combine keywords to identify a position in the text embedding for the target embedding, as this can decrease the sensitivity to formatting, number, and/or order of the keywords produced by the generative AI.

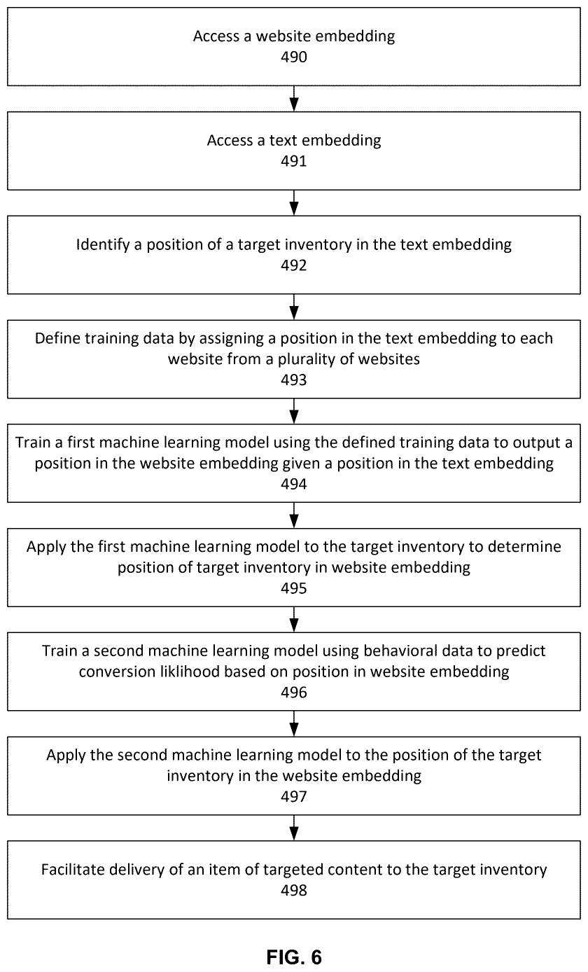

FIGS. 5 and 6 relate to training and/or applying machine learning models based on a website embedding space, a text embedding space, and/or likelihoods of conversion events. Conversion likelihood data can be collected using behavioral data observed through traffic data associated with websites. Some embodiments described herein relate to the training of and/or the application of a machine learning model to predict a conversion likelihood based on such web-based behavioral data. Such a conversion likelihood model, however, would traditionally be limited to making predictions for data having the same form as the training data, i.e., website-based data. A significant technical challenge exists, however, to accurately expanding a machine learning model trained using web-based behavioral data, to arbitrary inventory.

Some embodiments described herein, therefore, further relate to the training of and/or application of a machine learning model that can convert between a website embedding space and a text embedding space and/or vice versa. Such a model can be used to, for example, identify a position in the website embedding for arbitrary non-website inventory based on the non-website inventory's position in the text embedding. Then, given a position for arbitrary (e.g., non-web) inventory in the website embedding, a conversion likelihood model, trained using web-based conversion data and/or the positions of websites in a website embedding, can be applied to the arbitrary inventory's position in the website embedding. Alternatively, behavioral and/or conversion data can be associated with positions in the website embedding. Such data can be translated to the text embedding, where a machine learning model can be trained on such conversion data to predict a likelihood of conversion, given a position in the text embedding.

Accordingly, at block 480, a text embedding is accessed. A text embedding is a vector space the encodes the semantic meaning of words. Vector representations of words in the text embedding can be used to identify relationships between words, for example, as words with similar meaning can be represented by vectors that are close together in the embedding space.

At 481, a position of one or more websites in the text embedding is identified. For example, keyword extraction, topic extraction, or description extraction may be performed in instances where those keywords, topics, or descriptors are related the content on the page (e.g., video, image, or other visual/structural aspects of the page). Additionally or alternatively, the websites' URL, publisher provided descriptions, descriptors, or keywords for the website from website metadata may be used. The website(s) position in the text embedding can be identified by processing various aspects of the website, such as text, metadata, structure, and/or visual elements to encode the various aspects into a numerical vector and place the website in the word vector space at a specific point where the position reflects the semantic or contextual relationship of the website (or words extracted from the website) to other words. In addition or alternatively, the method of FIG. 4 can be applied to the website(s), content extracted from websites, websites' URLs, etc. to assign keywords and/or positions, and such keywords can be located in the text embedding.

In instances in which the websites whose positions have been identified in the text embedding at 481 are also associated with positions in a website embedding (e.g., the website embedding discussed above wither reference to FIG. 2), assigning positions in the text embedding to such websites can constitute a training data set that can be used to train a first machine learning model, at 482, that is operable to predict a position in the text embedding, given a position in a website embedding and/or vice versa.

Similar techniques to those discussed above with reference to identifying positions of inventory in text embeddings with respect to FIG. 4 and/or techniques discussed with reference to identifying positions of websites in text embeddings at 481 can be used to identify a position of target inventory in the text embedding, at 483. For example, for connected TV (CTV) inventory, descriptions of shows, genres, or channels can be directly embedded. Those descriptions can either be provided by the publisher or generated by generative AI. Optionally, generative AI can be used to extract keywords from those descriptions. This could also be used to find website embeddings for websites where there was not enough behavioral data to train a mapping natively (e.g., a new or less frequently visited site) by using the same techniques to generate text data as were used for the training domains. Similarly, text descriptions of any kind of advertising inventory, in-app mobile inventory, out of home (OOH) inventory, audio inventory, print inventory, etc. (does not have to be digital) may be used. The trained model can map that inventory from language embedding space to website embedding space, and now that the target inventory is in website embedding space, any web-based behavioral model may be scored against the target inventory to predict the value of the inventory to an advertiser from a behavioral perspective.

At 484, a second machine learning model trained to predict a conversion likelihood is accessed. The second machine learning model can be trained on behavioral data associated with web visitation histories. The second machine learning model can be trained to predict conversion likelihood based on position in the text embedding and/or based on position in the website embedding.

In some instances, training data can be defined for the second machine learning model that includes positions in the website embedding. Each position in the website embedding can be associated with a website and associated with conversion event data associated with that website. The second machine learning model can be trained using such data to predict a likelihood of conversion, given a position in the website embedding.

In some embodiments, instead of training the second machine learning model to predict a likelihood of conversion, given a position in the website embedding, the training data can be translated to the text embedding, using the first machine learning model. In such an embodiment, the translated training data can be associated with a position in the text embedding and conversion event data. The second machine learning model can thus be trained using the translated training data to predict a likelihood of conversion, given a position in the text embedding.

In some embodiments, website-based behavioral data can be imported directly to the text embedding without accessing or relying on a website embedding. For example, positions of each of a group of websites can be identified in the text embedding. Behavioral data (e.g., conversion event data) associated with each website can then be associated with the corresponding position in the text embedding. Such behavioral data, associated with positions in the text embedding, can be used as training data to train the second machine learning model to predict a likelihood of conversion, given a position in the text embedding.

At 486, the first machine learning model and/or the second machine learning model can be applied to the position of the target inventory in the text embedding to predict a likelihood of conversion. The first machine learning model and the second machine learning model can be applied in any sequence, or simultaneously. For example, in instances in which the second machine learning model is trained to predict a likelihood of conversion given a position in the website embedding, the first machine learning model can be applied to the position of the targeted inventory in the text embedding (identified at 483) to identify a position of the target inventory in the website embedding. Then, the second machine learning model can be applied to predict a likelihood of conversion for the target inventory based on the position of the target inventory in the website embedding. As an alternative example in which the second machine learning model is trained to predict a likelihood of conversion given a position in the text embedding, the application of the first machine learning model to the training data can constitute applying the first machine learning model, at 486. As yet another alternative, for example when website-based behavioral data is imported directly to the text embedding without accessing or relying on a website embedding, the second machine learning model can be applied to the position of the target inventory in the text embedding to predict a likelihood of conversion, without the involvement of a first machine learning model to translate information between text embedding and website embedding.

At 487, an item of targeted content can then be delivered (or delivery of the item of targeted content can be facilitated, for example, by identifying to a third party suitable targeted content and/or conversion likelihood). This allows for more personalized content being shown to a user because of the association of the behavioral data.

FIG. 6 is a method flowchart depicting a second method by which inventory is selected for targeted content delivery. A website embedding is accessed at 490 and a text embedding is accessed at 491. Similar to accessing the text embedding at 480 of FIG. 5, accessing a website embedding refers to accessing a representation of a vector space that encodes similarities between websites, for example, based on observed browsing data. By accessing a website embedding, an arbitrary website can be compared to previously identified and/or mapped websites in an efficient, data-driven manner.

At 492, a position of target inventory is identified in the text embedding space. This can be similar to identifying the position of target inventory discussed above with reference to FIG. 5 and event 483.

At 493, training data is defined by assigning a position in the text embedding to each website from a plurality of websites. Identifying positions in the text embedding for websites can be similar to identifying positions of websites in the text embedding discussed above with reference to FIG. 5 and event 481. This training data is used at 494, where a first machine learning model is trained to output a position in the website embedding given a position in the text embedding. In addition or alternatively, the first machine learning model and/or a third machine learning model can be trained, for example, using the training data defined at 493 to output a position in the text embedding given a position in the website embedding.

At 495, the first machine learning model is applied to the target inventory to determine a position in the website embedding for the target inventory.

At 496, a second machine learning model can be trained to predict a likelihood of conversion, given a position in the website embedding. The second machine learning model can be trained on behavioral data associated with web visitation histories. In some instances, training data can be defined for the second machine learning model that includes positions in the website embedding. Each position in the website embedding can be associated with a website and associated with conversion event data associated with that website. The second machine learning model can be applied, at 497, to the position of the target inventory in the website embedding, to predict a conversion probability associated with the target inventory.

At 498, an item of targeted content can then be delivered (or delivery of the item of targeted content can be facilitated, for example, by identifying to a third party suitable targeted content and/or conversion likelihood). This allows for more personalized content being shown to a user because of the association of the behavioral data.

Some embodiments described herein relate to methods. It should be understood that such methods may be computer-implemented methods (e.g., instructions stored in memory and executed on processors). Where methods described above indicate certain events occurring in certain order, the ordering of certain events may be modified. Additionally, certain of the events may be performed repeatedly, concurrently in a parallel process when possible, as well as performed sequentially as described above. Furthermore, certain embodiments may omit one or more described events.

Some embodiments described herein relate to computer-readable medium. A computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as ASICs, PLDs, ROM and RAM devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

1. A non-transitory, processor-readable medium storing code configured to be executed by a processor, the code comprising instructions to cause the processor to:
access a text embedding space;
identify a position of each website from a first plurality of websites in the text embedding space;
identify a position of a target inventory in the text embedding space, the target inventory not being a website;
train a first machine learning model using the position of each website from the first plurality of websites in the text embedding space to convert at least one of (i) a position in the text embedding space to a position in a website embedding space or (ii) a position in the website embedding space to a position in the text embedding space;
access a second machine learning model, the second machine learning model trained to predict a conversion likelihood based on behavioral data representing user interactions with a second plurality of websites;
convert, using the first machine learning model, (i) the position of the target inventory in the text embedding space to a target position in the website embedding space or (ii) a position of each website from the second plurality of websites in the website embedding space to a position of that website in the text embedding space, to produce vector data that represents the target inventory and the second plurality of websites in a common embedding space;
predict the conversion likelihood using the second machine learning model, based on the vector data, and without using a cookie; and
facilitate delivery of an item of targeted content to the target inventory based on the conversion likelihood associated with the target inventory.

2. The non-transitory, processor-readable medium of claim 1, wherein the second machine learning model is trained to predict the conversion likelihood based on a position in the website embedding space.

3. The non-transitory, processor-readable medium of claim 1, wherein:
the code to cause the processor to convert causes the processor to identify the target position in the website embedding space; and
the conversion likelihood is predicted by inputting the target position in the website embedding space into the second machine learning model.

4. The non-transitory, processor-readable medium of claim 3, wherein the second machine learning model is trained to predict the conversion likelihood based on a position in the website embedding space.

5. The non-transitory, processor-readable medium of claim 1, wherein the code to cause the processor to convert causes the processor to identify a position of each website from the second plurality of websites in the text embedding space, the code further comprising code to cause the processor to:
label training data for the second machine learning model such that the position of each website from the second plurality of websites is associated with behavioral data associated with that website; and
train the second machine learning model using the training data for the second machine learning model such that the second machine learning model is configured to predict the conversion likelihood given the position of the target inventory in the text embedding space.

6. A non-transitory, processor-readable medium storing code configured to be executed by a processor, the code comprising instructions to cause the processor to:
identify a target inventory that is non-website inventory;
prompt a generative artificial intelligence (AI) with the target inventory, wherein the prompt causes the generative AI to produce keywords associated with the target inventory;
access a text embedding space;
assign a position in the text embedding space for the target inventory based on an output of the generative AI;
access behavioral data including, indications of a plurality of websites visited by a user and an indication of a conversion action;
map the behavioral data in a website embedding space based on locations of the plurality of websites;
train a first machine learning model, using the behavioral data in the website embedding space to predict a likelihood of conversion based on a position in the website embedding space;
convert a position of the target inventory in the text embedding space to produce a position of the target inventory in the website embedding space using a second machine learning model;
predict, without using a cookie, the likelihood of conversion of the target inventory, using the first machine learning model, based on the position of the target inventory in the website embedding space; and
facilitate delivery of the target inventory based on the likelihood of conversion.

7. The non-transitory, processor-readable medium of claim 6, wherein the code to cause the processor to assign the position further comprises instructions to cause the processor to:
define a vector in the text embedding space for the target inventory based on keywords produced by the generative AI.

8. The non-transitory, processor-readable medium of claim 7, the code further comprising instructions to cause the processor to aggregate vector positions representing the keywords to produce an aggregate keyword vector, the vector defined based on the aggregate keyword vector.

9. A non-transitory, processor-readable medium storing code configured to be executed by a processor, the code comprising instructions to cause the processor to:
access a website embedding space;
access a text embedding space;
identify a position of a target inventory in the text embedding space, the target inventory not being a website;
define training data by assigning a position in the text embedding space to each website from a plurality of websites, each website from the plurality of websites having a position in the website embedding space;
train a first machine learning model, using the training data, to output a position in the text embedding space, given a position in the website embedding space;
convert a position of the target inventory in the text embedding space, using the first machine learning model, to a target position in the website embedding space;
input the target position in the website embedding space to a second machine learning model to predict a conversion likelihood based on a position in the website embedding space and without using a cookie; and
facilitate delivery of an item of targeted content to the target inventory based on the conversion likelihood for the target inventory.

10. The non-transitory, processor-readable medium of claim 9, wherein the code to cause the processor to train the first machine learning model further comprises code to train at least one of the first machine learning model or a third machine learning model, using the training data, to output a position in the website embedding space, given a position in the text embedding space.

11. The non-transitory, processor-readable medium of claim 9, wherein the code to cause the processor to identify the position of the target inventory in the text embedding space includes code to cause the processor to prompt a generative artificial intelligence (AI) with the target inventory to cause the generative AI to produce keywords associated with the target inventory, the position in the text embedding space identified based on the keywords.

12. The non-transitory, processor-readable medium of claim 9, wherein the code to cause the processor to identify the position of the target inventory in the text embedding space includes code to cause the processor to:
prompt a generative artificial intelligence (AI) with the target inventory to cause the generative AI to produce keywords associated with the target inventory; and
define a vector in the text embedding space for the target inventory based on the keywords.

13. The non-transitory, processor-readable medium of claim 9, wherein the code to cause the processor to define the training data includes code to cause the processor to extract at least one keyword, topic, or description from text content of each website from the plurality of websites.

14. The non-transitory, processor-readable medium of claim 9, wherein the code to cause the processor to define the training data includes code to cause the processor to extract at least one of a universal resource locator (URL) or website title of each website from the plurality of websites.

15. The non-transitory, processor-readable medium of claim 9, wherein the target inventory is a connected television (CTV) inventory.

16. The non-transitory, processor-readable medium of claim 9, wherein the code to cause the processor to identify the position of the target inventory in the text embedding space includes code to cause the processor to prompt a generative artificial intelligence to produce keywords for the item in targeted content in a json format.

17. The non-transitory, processor-readable medium of claim 9, wherein the code to cause the processor to identify the position of the target inventory in the text embedding space includes code to cause the processor to prompt a generative AI to summarize a description of the targeted inventory present on a webpage.

18. The non-transitory, processor-readable medium of claim 1, wherein the code configured to cause the processor to identify a position of a target inventory in the text embedding space further includes code to cause the processor to prompt a generative artificial intelligence to provide a description of the target inventory.

19. The non-transitory, processor-readable medium of claim 1, wherein the second machine learning model is trained to predict the conversion likelihood based on a position in the text embedding space.

20. The non-transitory, processor-readable medium of claim 1, wherein the code to configured cause the processor to apply the first machine learning model includes code to cause the processor to train the second machine learning model by applying the first machine learning model to the behavioral data.
